(19) United States
(12) Patent Application Publication
(10) Pub. No.: US 2025/0206116 A1
(43) Pub. Date: Jun. 26, 2025

(54) RUN CHANNEL FOR A MOVABLE WINDOW FRAME OF A VEHICLE AND METHOD FOR MANUFACTURING THE SAME

(71) Applicant: HUTCHINSON, PARIS (FR)

(72) Inventors: Olivier BLOTTIAU, AMILLY (FR); Cyril LAJOUX, VIMORY (FR); Hubert BELLI, PARIS (FR); Benjamin SEGOND, PARIS (FR); Franck EMO, PARIS (FR)

(21) Appl. No.: 18/990,609

(22) Filed: Dec. 20, 2024

(30) Foreign Application Priority Data
Dec. 22, 2023 (FR) 2315059

(51) Int. Cl. B60J 10/76

(52) U.S. Cl. CPC B60J 10/76

(57) ABSTRACT

A run channel for a movable window frame of a vehicle is disclosed. This run channel comprises at least first and second profiles each comprising at least one sealing lip and connected together in a secant manner by at least one connecting portion. The first profile comprises an appearance finish coating which comprises at least one finish selected from a gloss, a coloration and a surface finish. The first profile is formed by co-extrusion with said appearance finish coating, the second profile is formed by co-extrusion, said at least one connecting portion is formed by an overmolding material, and the run channel comprises an appearance finish end piece which is located at at least one longitudinal end of the first profile and of the coating.

### CROSS-REFERENCE TO RELATED APPLICATION(S)

This present application claims priority to French Patent Application No. 2315059, filed Dec. 22, 2023, the disclosures of which are hereby incorporated by reference in their entireties.

### TECHNICAL FIELD

The present disclosure relates to the field of vehicles, for example motor vehicles. More particularly, the present disclosure concerns a run channel for a movable window frame of a vehicle, and a method for manufacturing such a run channel.

### BACKGROUND

The prior art comprises in particular the documents JP-A-2001322436, WO-A1-2014/188004 and JP-A-2007320369.

It is known that a motor vehicle comprises several doors, each equipped with a lower shell and an upper frame. The upper frame, also referred to as the “window frame”, is configured to receive a movable (or sliding) window of the vehicle. Each door comprises a run channel having a portion located in the lower shell and a portion extending at the level of the window frame, in particular around this window frame. This run channel allows to guide the movable window, which slides in place in the door and also provides a seal between the door and the movable window.

The run channel generally comprises a first horizontal upper profile (or segment) and two vertical profiles, the second and third respectively, connected to each other by the first profile. The run channel then has a general inverted U shape. However, this shape may be more complex, particularly if the run channel is connected to a stationary window.

Each of the profiles comprises at least one sealing lip.

The door may also comprise at least one appearance finish coating that extends along one of the profiles, in particular the first profile, and an appearance finish end piece located at a longitudinal end of this coating. The appearance finish coating is generally formed by a trim piece which is fitted to the profile and comprises an aesthetic visible surface, for example typically chrome, brushed or gloss black.

There are different ways of making such a run channel for a movable window frame. One example of embodiment involves forming two profiles separately and then, if necessary, shaping them by thermoforming to fit it or them to the shape of the window frame. The profiles are then placed in a mold and a connecting portion is formed by injection molding so as to connect the profiles together. The trim piece forming the appearance finish coating is fitted and attached to one of the profiles after the run channel has been mounted. Finally, the appearance finish end piece is mounted at the longitudinal end of the profile.

However, making such a prior art run channel and mounting this run channel in the vehicle may be complex, costly and time-consuming. The particular shape of the U-shaped run channel means that the profiles have to be deformed during the mounting, which means that flexible or deformable materials have to be used. However, the trim piece and the appearance finish end piece are generally made of a rigid material (typically metal). They are therefore mounted to one of the profiles at the end of the run channel mounting. This adds extra steps to the assembly of the door, and therefore additional mounting complexity.

If the appearance finish coating is formed directly on the trim piece, by a painting for example, the deformation of the profiles during mounting could cause cracks in the coating, damaging it. In addition, these cracks may be visible and therefore also alter the aesthetic appearance of the run channel.

In addition, some parts of the run channel (e.g. the appearance finish end piece) are not particularly aesthetic and may damage the overall aesthetics of the vehicle.

In this context, it is interesting to overcome at least some of the disadvantages of the prior art, by proposing a run channel for a movable window frame of a vehicle that is more aesthetic and easier to make and assemble.

### SUMMARY

The present disclosure offers a simple, effective, economical and aesthetic solution to at least some of the aforementioned disadvantages.

To this end, the disclosure relates to a run channel for a movable window frame of a vehicle, this run channel comprising at least first and second profiles each comprising at least one sealing lip and connected to one another in a secant manner by at least one connecting portion, said first profile comprising an appearance finish coating which extends along this first profile and which comprises at least one first finish selected from a gloss, a matting, a coloration and a surface finish different from that of the rest of the profile.

According to the disclosure, the first profile is formed by co-extrusion with said appearance finish coating; the second profile is formed by co-extrusion; and said at least one connecting portion is formed by an overmolding material.

According to the disclosure, the run channel comprises at least one appearance finish end piece which is located at at least one longitudinal end of said first profile and said appearance finish coating, this end piece having at least one second finish chosen from a gloss, a matting, a coloration and a surface finish.

In general, the present disclosure allows to simplify and facilitate the production of the run channel and its mounting in the vehicle, while improving its aesthetic appearance. To achieve this, the disclosure proposes, on the one hand, co-extruding the first profile and the appearance finish coating in a single piece and, on the other hand, obtaining by overmolding (or molding) the connecting portion integrally secured to the first and second profiles in a manufacturing mold. The co-extrusion and overmolding steps of the disclosure make it quick and easy to form the run channel in a single piece. This allows to avoid the need for additional steps (e.g. assembling the appearance finish coating on the first profile, profile thermoforming, etc.) and reducing the production costs.

In addition, producing the end piece with a particular finishing (for example identical or different to the coating on the first profile) allows to enhance the aesthetic finish of the run channel.

In this way, the run channel according to the disclosure significantly improves the overall aesthetics of the vehicle.

In the present application, a secant connection means that two profiles intersect at a point, referred to as intersection. For this purpose, the first profile extends along a longitudinal axis and the second profile extends along an axis of elongation which is substantially perpendicular (or inclined) to the longitudinal axis of the first profile.

These first and second profiles are connected to each other by the connecting portion which is located at the point of intersection (or in other words the point where the first and second profiles meet).

Advantageously, the appearance finish end piece and/or the appearance finish coating have a gloss greater than or equal to 70 GU at 60° and/or a flexural modulus of between 200 and 3000 MPa at ambient temperature. Even better, the appearance finish end piece and/or the appearance finish coating comprise a material free of metal particles, and have a gloss greater than or equal to 70 GU at 60° and/or a flexural modulus of between 200 and 3000 MPa at ambient temperature. The flexural modulus of between 700 and 3000 MPa offers a number of advantages, such as providing abrasion resistance for the coating and providing a flexibility in the coating to prevent any cracks/breaks in the coating when the run channel is mounted on a frame comprising a significant curvature (from 150 mm).

The run channel according to the disclosure may comprise one or more of the following characteristics taken individually or in combination with each other:
the appearance finish end piece and/or the appearance finish coating have a matting of less than or equal to 10 GU at 60° and/or a flexural modulus of between 200 and 500 MPa at ambient temperature;
the appearance finish end piece and/or the appearance finish coating comprise a material free of metal particles, and have a matting of less than or equal to 10 GU at 60° and/or a flexural modulus of between 200 and 500 MPa at ambient temperature;
the appearance finish end piece and/or the appearance finish coating comprise a material with a color difference ΔE of the Lab type of less than 15; preferably this difference ΔE is less than 7; more preferably this difference ΔE is less than 5; even more preferably this difference ΔE is less than 2;
the appearance finish end piece and/or appearance finish coating comprise a material free of metal particles, with a color difference ΔE of the type Lab less than 15; preferably this difference ΔE is less than 7; more preferably this difference ΔE is less than 5; even more preferably this difference ΔE is less than 2;
the appearance finish end piece and/or the appearance finish coating comprise a material free of metal particles;
the appearance finish end piece and/or the appearance finish coating is (or are) made of a material free of metal particles;
the appearance finish coating covers a median portion of a U-section longitudinal portion of the first profile, and optionally a lateral wall of this median portion or a lateral arm which extends in the prolongation of the median portion;
said median portion and said lateral wall are made of polypropylene;
the arm is made of polypropylene;
said appearance finish end piece covers an edge of said appearance finish coating;
said appearance finish end piece is fitted or is formed by overmolding of an appearance material;
said appearance finish coating, or even said appearance finish end piece, comprises an appearance finish material based on polypropylene, styrenic thermoplastic polyolefin (TPS), vulcanized thermoplastic (TPV), styrenic thermoplastic elastomer (TPES) or vulcanized thermoplastic elastomer (TPEV), and/or may comprise at least one nucleating agent in a proportion of 0.01 to 5% by weight;
the polypropylene-based appearance finish material has a proportion at least of approximately 90% by weight of the total weight of the appearance finish coating or of the appearance finish end piece;
the polypropylene-based appearance finish material has a proportion of between 90% and 99% by weight relative to the total weight of the appearance finish coating or of the appearance finish end piece;
the polypropylene-based appearance finish material has a proportion of between 95% and 99% by weight relative to the total weight of the appearance finish coating or of the appearance finish end piece;
the overmolding material is chosen from a styrenic thermoplastic (TPS), a vulcanized thermoplastic (TPV), a styrenic thermoplastic elastomer (TPES) and a vulcanized thermoplastic elastomer (TPEV);
the run channel is preferably made entirely of recyclable polypropylene-based materials;
the first and second finishes are identical;
the first finish is a combination of at least two first finishes, each chosen from gloss, matting, coloration and surface finish;
the first finish is chosen from coloration and/or gloss;
the second finish is chosen from a matting and/or a surface finish;
the first finish of the appearance finish coating is different from the second finish of the end piece;
the appearance finish coating has a thickness of less than 1 mm, and preferably the thickness of this coating is between 0.25 and 0.90 mm;
the first and second profiles each comprise at least two sealing lips; and
the coloration of the first finish and/or of the second finish may be a coloration other than black.

As far as the nucleating agent is concerned, it allows to provide a particularly aesthetical finish, and in particular an improved gloss compared to a plastic material free of nucleating agent.

The disclosure also relates to a vehicle, in particular a motor vehicle, comprising at least one run channel according to the disclosure.

The disclosure also relates to a method for manufacturing a run channel according to one of the characteristics of the disclosure. The method comprises the following steps:
(a) producing the first and second profiles independently of each other by co-extrusion, each of the first and second profiles comprising at least one sealing lip, the first profile comprising said appearance finish coating which is co-extruded with the rest of this first profile,
(b) positioning first and second profiles in a mold,
(c) injecting an overmolding material into the mold to form said at least one connecting portion of said first and second profiles, and
(d) forming or mounting the appearance finish end piece on said longitudinal end of said first profile and said appearance finish coating, step (d) being carried out before step (b), after step (c), or simultaneously with step (c).

According to a first example of embodiment of the method, step (d) of forming the appearance finish end piece may be carried out after step (c) by overmolding, in a different mold from the one used for step (c) of injecting the overmolding material.

According to a second example of embodiment of the method, the step (d) of forming the appearance finish end piece is carried out before step (b) by overmolding in a different mold from the one used for step (c) of injecting the overmolding material.

According to a third example, step (d) of mounting the appearance finish end piece may be carried out before step (b) or after step (c), the end piece being previously produced by injection-molding.

According to a fourth example of embodiment of the method, steps (c) and (d) may be carried out simultaneously by injection or bi-injection of the overmolding material to form the at least one connecting portion, and of an appearance material to form said end piece.

According to a variant embodiment of this fourth example, the overmolding material to form the connecting portion may be identical to the appearance material used to form the end piece. In this way, the connecting portion and the end piece may be made of the same material.

According to another variant of implementation of the fourth example, steps (c) and (d) may be carried out by bi-injection when the overmolding material for forming the connecting portion is different from the appearance material to form the end piece.

### BRIEF DESCRIPTION OF THE DRAWINGS

The disclosure will be better understood and other details, characteristics and advantages of the disclosure will become clearer on reading the following description made by way of non-limiting example and with reference to the annexed drawings wherein:

FIG. 1 is a schematic view of an exterior side of a door of a motor vehicle comprising a window frame provided with a run channel according to the disclosure;

FIG. 2 is a partial schematic view of an outer side of the run channel in FIG. 1;

FIG. 3 is a schematic cross-section in plane II-II of the run channel of the window frame in FIG. 2;

FIG. 4 is a schematic sectional view in plane II-II of a variant of the run channel of the window frame in FIG. 2;

FIG. 5 is an enlarged schematic view of the run channel in FIG. 2 comprising an appearance finish end piece according to a first embodiment;

FIG. 6 is a schematic view of FIG. 5 from above and in perspective;

FIG. 7 is a schematic side and perspective view of FIG. 5 or 6;

FIG. 8 is a partial schematic perspective view of the run channel of FIG. 2 with the appearance finish end piece in a second embodiment;

FIG. 9 is a block diagram of a manufacturing method for manufacturing the run channel of the disclosure;

FIG. 10 is a block diagram of a first variant of the manufacturing method for manufacturing the run channel of the disclosure; and

FIG. 11 is a block diagram of a second variant of the manufacturing method for manufacturing the run channel of the disclosure.

The elements with the same functions in the different implementations have the same references in the figures.

### DETAILED DESCRIPTION

By convention, in the following description, the terms “longitudinal” and “axial” refer to the orientation of structural elements extending in the direction of a longitudinal axis. The terms “radial” or “vertical” refer to an orientation of structural elements extending along a direction perpendicular to the longitudinal axis. The term “lateral” refers to a structural element extending to one side of the longitudinal axis, for example.

The present disclosure is generally applicable to a vehicle, for example a motor vehicle. The vehicle may comprise at least one movable window frame with at least one run channel.

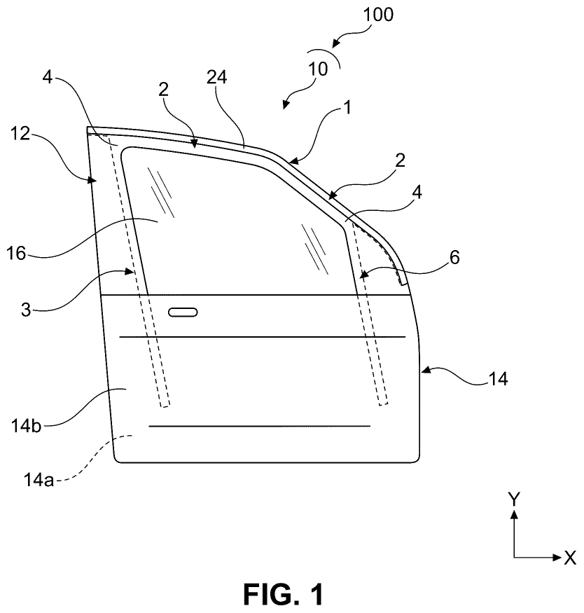

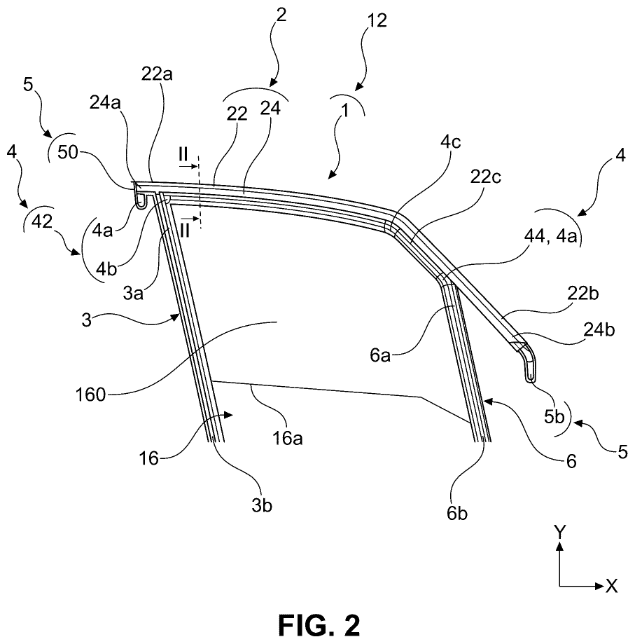

FIGS. 1 and 2 show an example of a door 10 on a vehicle 100 and its run channel 1. The door 10 may extend along a longitudinal axis X (shown in a horizontal direction in the figures) and an elongation axis Y (shown in a vertical direction in the figures) which is substantially perpendicular to the axis X. This door 10 is divided into a first upper part (with respect to the axis Y) forming a window frame 12 and a second lower part (with respect to the axis Y) forming a lower shell 14.

The shell 14 may comprise a first inner panel 14a (relative to the inside of the vehicle) and a first outer panel 14b (relative to the outside of the vehicle). These first inner and outer panels 14a, 14b are configured to house at least a part of a window 16 of the door 10. This window 16 is movable (or sliding) up and down, and vice versa. The first inner and outer panels 14a, 14b may be made from sheet steel or any other suitable material.

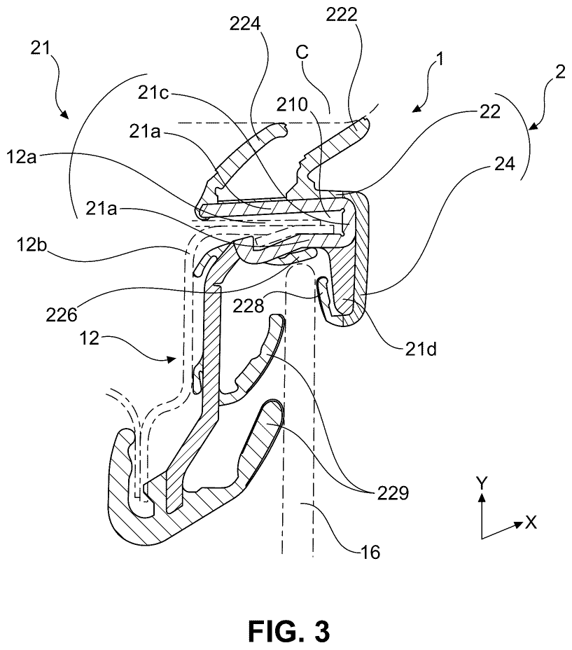

The window frame 12 may operate as a frame holding at least one peripheral edge 16a of the window 16 when it is in the raised position. The window frame 12 comprises a window opening 160, and the window 16 is configured to cover or uncover this opening 160 in its upper and lower positions respectively. The window frame 12 may comprise second inner 12a and outer 12b panels, as shown by way of example in FIG. 3. The second inner and outer panels 12a, 12b may be made from a steel sheet or any other suitable material. These second inner and outer panels 12a, 12b allow to form a support for mounting a run channel 1.

As described above, the run channel 1 has a part located in the shell 14 and a part extending around the window frame 12.

The run channel 1 according to the disclosure will now be described with reference to FIGS. 1 to 7. This run channel 1 allows to guide the window 16 to slide in the door 10 and ensures a seal between the door 10 and the window 16.

The run channel 1 may be generally U, V or L shaped.

The run channel 1 comprises at least first 2 and second 3 profiles connected to each other. Each of the first 2 and second 3 profiles comprises at least one sealing lip 222-228, 262, 264.

The first profile 2 may extend longitudinally along the axis X. The first profile 2 may comprise a longitudinal portion 22.

The longitudinal portion 22 may comprise first 22a and second 22b longitudinal ends opposite each other. In this way, the longitudinal portion 22 may extend between the first 22a and second 22b longitudinal ends in one-part and in a single piece (i.e. from a single piece). The longitudinal portion 22 may be evenly curved from one end to the other. The second longitudinal end 22b may be inclined relative to the first longitudinal end 22a, for example radially towards the body 14 of the door (relative to the axis Y).

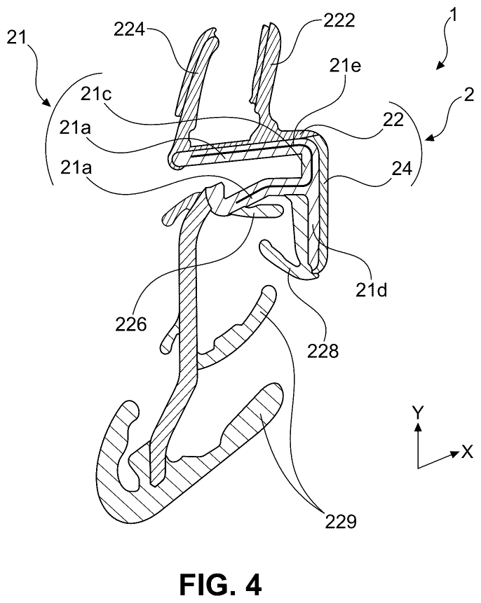

With reference to FIGS. 3 and 4, the longitudinal portion 22 may comprise first 222 and second 224 sealing lips, referred to as upper lips. These first 222 and second 224 upper lips may extend radially and along the longitudinal portion 22 and the axis X. The first 222 and second 224 upper lips may be parallel to each other. The first 222 and second 224 upper lips may be configured to be in contact with an element of body C of the vehicle 100 when the door 10 is in the closed position. The longitudinal portion 22 may comprise first 226 and second 228 sealing lips, referred to as intermediate lips. These first 226 and second 228 intermediate lips may extend radially and along the longitudinal portion 22 and the axis X. In the example shown in FIG. 3, the first 226 intermediate lip may extend substantially perpendicular to the second 228 intermediate lip. In the example shown in FIG. 4, the second 228 intermediate lip may be inclined relative to the second first 226 intermediate lip. The first 226 and second 228 intermediate lips may be configured to be in contact with at least a part of the window 16 when this window 16 completely covers the opening 160.

FIGS. 3 and 4 illustrate, in a non-limiting way, other sealing lips of the first profile 2 to seal the run channel 1 with respect to the elements of the window frame 12. For example, the longitudinal portion 22 may comprise sealing lips 229, referred to as lower lips (with respect to the axis Y). There may be two of these lower sealing lips 229 in the example shown in FIGS. 3 and 4. The lower sealing lips 229 may extend radially, for example towards the body C (relative to the axis Y), and along the longitudinal portion 22. The lower sealing lips 229 may be configured to be in contact with at least a part of the window 16 when this window 16 completely covers the opening 160.

The upper 222, 224, intermediate 226, 228 and lower 229 lips are used to seal the element of body C and the window 16 respectively. At least one of the upper 222, 224, intermediate 226, 228 and lower 229 lips may be formed integrally with the longitudinal portion 22.

In the example shown in FIG. 3, all the sealing lips 222-229 are formed integrally with the longitudinal portion 22.

With reference to FIG. 2, the longitudinal portion 22 may comprise an intermediate segment 22c connecting at least some of the first and second segments of the longitudinal portion 22 together, for example by a fastener 4c. The first and second segments comprise, respectively, the first 22a and second 22b longitudinal ends.

The fastener 4c and the connecting portion 4 may be made of the same material (i.e. a so-called overmolding material described below). As illustrated in FIGS. 3 and 4, the longitudinal portion 22 of the first profile 2 may have a main cross-section as follows in a U shape. This U-shaped longitudinal portion 22 may comprise a median portion 21, referred to as the longitudinal body. This median portion 21 may be covered with an appearance finish coating 24. The median portion 21 may comprise an internal cavity 210 allowing to receive the outer and inner panels 12a, 12b, for example.

In particular, the median portion 21 may comprise at least one top wall 21a, a bottom wall 21b and a lateral wall 21c connecting the top wall 21a and bottom wall 21b together. The lateral wall 21c may extend as an extension of the median portion 21. The walls 21a, 21b, 21c extend along the axis X. The walls 21a, 21b, 21c may be formed integrally with the median portion 21. The top wall 21a may be connected to the upper sealing lips 222, 224, the bottom wall 21b may be connected to the intermediate sealing lips 226, 228 and the lateral wall 21c may be level with the appearance finish coating 24 of the first profile 2. In particular, the coating 24 may cover the lateral wall 21c.

The lateral wall 21c may be extended by an arm 21d. This arm 21 may extend radially towards the second 228 intermediate lip under the coating 24. In other words, the arm 21d may be interposed between the second 228 intermediate lip and the coating 24.

The median portion 21, and possibly the arm 21d, may be made from polypropylene. The walls 21a, 21b and 21c may be made from polypropylene.

Advantageously, the median portion 21 may be reinforced by a metal core 21e or by fillers such as talc or glass fiber (FIG. 4). The lateral wall 21c and the arm 21d may form a rigid support configured to hold the coating 24 securely without any risk of buckling.

The first profile 2 therefore comprises the appearance finish coating 24 which extends along this first profile 2. More particularly, the coating 24 extends along the longitudinal portion 22 (i.e. between these first 22a and second 22b longitudinal ends). In the example shown in FIG. 2, the coating 24 extends substantially in the center of the longitudinal portion 22. In other words, the coating 24 may separate the longitudinal portion 22 into two radially internal and external pieces (in relation to the axis Y).

The coating 24 may comprise a third and/or a fourth longitudinal end located at the level of the first longitudinal end 22a and of the second longitudinal end 22b. These third and/or fourth longitudinal ends may comprise a free edge 24a, 24b. One of the edges 24b may have an opening into the internal cavity 210 of the run channel.

Preferably, the appearance finish coating 24 may be made from a different material to that of the first profile 2, particularly the longitudinal portion 22. The coating 24 comprises an aesthetic/decorative visible surface. To achieve this, the coating 24 comprises at least a first finish selected from a gloss, a matting, a coloration and a surface finish that is different from the rest (particularly the profiles 2, 3 and 6). Preferably, the first finish may be chosen from gloss and/or coloration.

The coloration of the coating 24 may be a coloration different from black.

The coloration of the coating 24 may be chosen from a chrome, brushed metal, blue, red, gold or gloss black coloration, for example.

The surface finish of the coating 24 may be rough, which may be obtained by graining or sandblasting, or satin-textured.

The coating 24 may comprise a material free of metal particles.

The gloss of the coating 24 may be greater than or equal to 70 GU (abbreviation for Gloss Unit) at 60°. For example, the gloss may be measured in accordance with ISO 2813.

The matting of the coating 24 may be less than or equal to 10 GU at 60°. For example, the matting may also be measured in gloss units in accordance with ISO 2813.

“Matting” refers to the visual appearance of the coating, which has little or no gloss.

Advantageously, the coating 24 may have a flexural modulus of between 200 to 3000 MPa at room temperature (for example between 18 and 24° C. and in particular at 23° C.). As mentioned above, the flexural modulus of the coating 24 allows to ensure a resistance to abrasion and provides a degree of flexibility for a crack/break-free integration.

The coating 24 with a gloss greater than or equal to 70 GU at 60° may have the flexural modulus of between 200 and 3000 MPa at room temperature. The coating 24, with matting of less than or equal to 10 GU at 60°, may have a flexural modulus of between 200 and 500 MPa at ambient temperature.

For example, the coating 24 may be made from polypropylene (PP), polyolefin, styrenic thermoplastic (TPS) or vulcanized thermoplastic (TPV), styrenic thermoplastic elastomer (TPES) or vulcanized thermoplastic elastomer (TPEV). These materials allow to provide flexibility (or deformability) to the appearance finish coating, making it easier to mount the run channel without damaging this finish. The coating 24 may comprise at least one nucleating agent such as Sorbitol. The nucleating agent may be in a proportion of 0.01 to 5% by weight.

The polypropylene-based coating 24 may comprise a proportion of at least about 90% by weight relative to the total weight of the coating 24. Preferably, this proportion of polypropylene may be between 90% and 99% by weight relative to the total weight of the coating 24. Even more preferably, the proportion of polypropylene may be between 95% and 99% by weight relative to the total weight of the coating 24. The coating 24 may have a Lab-type color difference ΔE of less than 15.

The color difference ΔE is a measure of difference between two colors. The formula for calculating the difference ΔE may be:

$$Δ E - {E}_{2 - 1} = \sqrt{{( {L}_{2}^{⋆} - {L}_{1}^{⋆} )}^{2} + {( {a}_{2}^{⋆} - {a}_{1}^{*} )}^{2} + {( {b}_{2}^{*} - {b}_{1}^{⋆} )}^{2}}$$

Where (L₁*; a₁*; b₁*) and (L₂*; a₂*; b₂*) are color space parameters for two different colors.

Advantageously: the parameter L* may have a difference ΔL (or L₂*−L₁* or L₂₋₁*) of between 1 and 5, preferably between 1 and 3; the parameter a* may be a difference Δa (or a₂*−a₁* or a₂₋₁) between 0.5 and 3 and the parameter b* may be a difference Δb (or b₂*-b₁* or b₂₋₁*) between 0.5 and 3.

Preferably, the difference ΔE may be less than 7. In this configuration, the difference ΔL may be about 5, the difference Δa may be about 3 and the difference Δb may be about 3.

More preferably, the difference ΔE may be less than 5. In this configuration, the difference ΔL may be about 3, the Δa difference may be about 3 and the Δb difference may be about 3.

Even more preferably, the difference ΔE may be less than 2.

The color difference ΔE of the Lab type of the coating 24 may be compared with the coloration of the appearance finish end piece 5.

The appearance finish coating 24 may be less than 1 mm thick.

This allows to reduce any shrinkage differences that may occur in relation to the first profile 2 coextruded with the coating 24. Preferably, the thickness of this coating 24 may be between 0.25 and 0.90 mm. A thickness of the coating 24 greater than 0.25 mm allows to prevent any transparency of the coating 24 with respect to the first profile 2, and ensures a uniform and homogeneous coverage of the coating 24 on the first profile 2.

The second profile 3 may extend substantially radially along the axis Y.

The second profile 3 may comprise first 3a and second 3b radial ends opposite each other.

In this way, the second profile 3 may extend between the first 3a and second 3b radial ends.

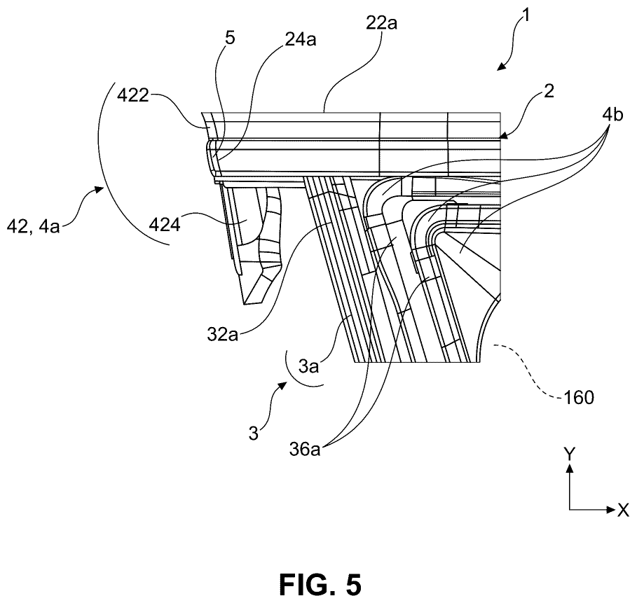

With reference to FIG. 5, the first radial end 3a may be divided into two end tips, first 32a and second 36a respectively. The first radial end 3a may be connected in a secant manner to the first profile 2, in particular at the first longitudinal end 22a.

The run channel 1 may thus have a general L or V shape when the first and second profiles 2, 3 are connected together. The second radial end 32 may be inserted into the lower shell 14 of the door.

In particular, the run channel 1 comprises a first connecting portion 42 configured as follows to connect the first 2 and second 3 profiles. In particular, the first portion 42 is configured to connect the first radial end 3a to the first longitudinal end 22a. This first portion 42 may be located at the end of the first profile 2 and/or of the second profile 3, thus forming a connecting end portion 4a.

With reference to FIG. 5, the first portion 42 may therefore comprise the end portion 4a allowing to connect the first end tip 32a to the longitudinal portion 22 (in particular to the first longitudinal end 22a). The first portion 42 may also comprise a curved connecting portion 4b. This curved portion 4b is configured to connect the second end tip 36a to the portion 22 (in particular at the first longitudinal end 22a).

The run channel 1 may comprise a third profile 6 also connected in a secant manner to the first profile 2. The third profile 6 may extend substantially along the axis Y. The third profile 6 may extend substantially parallel to the second profile 3, so as to form the U shape of the run channel 1.

The third profile 6 may comprise third 6a and fourth 6b radial ends opposite each other. The third radial end 6a may be connected in a secant manner to the first profile 2, in particular at the level of the second longitudinal end 22b (FIG. 2). The fourth radial end 6b may be connected to the shell 14 of door.

In particular, the run channel 1 may comprise a second connecting portion 44 configured to connect the first 2 and third 6 profiles. More specifically, the second portion 44 is configured to connect the third radial end 6a to the second longitudinal end 22b. This second portion 44 may be at of the first profile 2 and/or of the third profile 6, thus forming a connecting end portion 4a.

One of the special characteristics of the disclosure, in order to simplify the manufacture and the mounting of the run channel 1, is that:
the coating 24 and the first profile 2 are formed integrally by co-extrusion,
the second profile 3 (and/or the third profile 6) is formed by co-extrusion,
one or more of the connecting portions 4, 4a, 4b is/are formed by an overmolding material, and
the run channel 1 comprises at least one appearance finish end piece 5, 5a, 5b.

In particular, the longitudinal portion 22 is co-extruded with the coating 24 so as to form the first profile 2 integrally. This allows to simplify the production and the mounting of the run channel 1 and reduces the production costs.

The second profile 3 (and/or the third profile 6) is also produced by extrusion, to standardize and simplify the production of the run channel.

By “co-extrusion” we mean at least two elements, for example with different textures and/or functions, which are extruded together and simultaneously to form a single piece integrally.

In the case of the first profile 3, the longitudinal portion 22 may have a texture and also a function (i.e. sealing) different from those of the appearance finish coating 24.

The connecting portion 4, whether end 4a or curved 4b, may be formed by overmolding (or molding). The overmolding material is chosen from a styrenic thermoplastic (TPS), a vulcanized thermoplastic (TPV), a thermoplastic elastomer (TPE), a styrenic thermoplastic elastomer (TPES) and a vulcanized thermoplastic elastomer (VTE). The vulcanized thermoplastic may comprise polypropylene (PP) and/or ethylene-propylene-diene monomer (EPDM). The styrenic thermoplastic may comprise poly (styrene-butadiene-styrene) (SBS).

The end piece 5 is located at the first longitudinal end 22a and/or the second longitudinal end 22b of the first profile and of the coating 24 (in particular at at least one of the longitudinal ends of the coating 24). FIG. 2 provides a non-limiting illustration of two end pieces 5, 5a, 5b on the run channel 1.

Advantageously, a first end piece 5a may cover the edge 24a of the coating 24, and/or a second end piece 5b may cover the edge 24b of the coating 24. The end piece 5, 5a, 5b is used to laterally close at least part of the first profile 2 (in particular the internal cavity 210 at the level of the edge 24a, 24b).

Preferably, the end piece 5 may be made of a different material to the rest of the profile (2, 3, 6), particularly the longitudinal portion 22. The end piece 5 comprises a visible aesthetic/decorative surface. The end piece 5 may have at least one second finish selected from gloss, matte, coloration and surface finish. Preferably, the second finish may be a matt finish and/or a surface finish.

The second finish of the end piece 5 may be identical to the first finish of the appearance finish coating 24. Alternatively, the second finish of the end piece 5 may be different from the first finish of the appearance finish coating 24. For example, the second finish may have a different matting to the first finish. In another example, the first finish may have a different coloration and/or gloss from that of the second finish.

The coloration of the end piece 5 may be a coloration other than black.

According to another example, the second finish may have a different matting and/or surface finish from that of the first finish.

The end piece 5 may thus have a coloration chosen from chrome, brushed metal or gloss black coloration, for example.

The end piece 5 may comprise a material free of metal particles.

The end piece 5 may have a gloss of 70 GU or more measured at 60°.

The matting of the end piece 5 may be less than or equal to 10 GU at 60°.

Advantageously, the end piece 5 may have a flexural modulus of between 200 and 3000 MPa at ambient temperature. For example, the end piece 5 with the gloss greater than or equal to 70 GU at 60° may have the flexural modulus of between 200 and 3000 MPa at room temperature. The end piece 5 having a matting less than or equal to 10 GU at 60° may have a flexural modulus of between 200 and 500 MPa at ambient temperature.

The end piece 5 may have a rough surface finish, which may be obtained by graining or sandblasting or with a satin texture.

The end piece 5 may be made of a single or two materials.

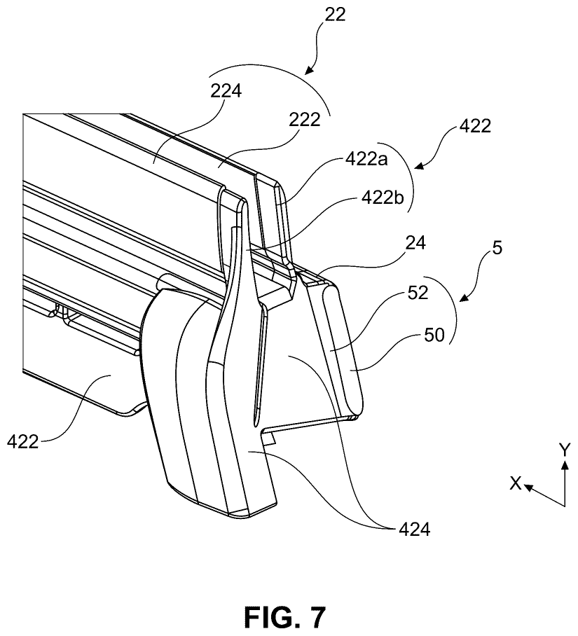

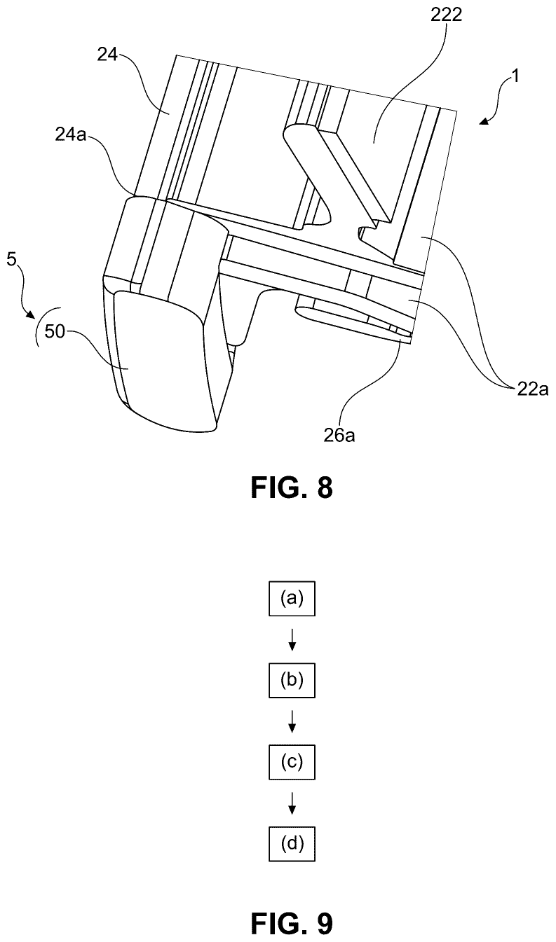

The end piece 5 may be fitted (FIG. 8), in particular to the first profile 2 (in particular to the first longitudinal end 22a and the appearance finish coating 24), or may be formed (FIGS. 5 to 7) by overmolding an appearance material. The appearance material may be different from the overmolding material forming the at least one connecting portion 4, 4a, 4b. The appearance material may be based on polypropylene, polyolefin, styrenic thermoplastic (TPS), vulcanized thermoplastic (TPV), styrenic thermoplastic elastomer (TPES) or vulcanized thermoplastic elastomer (TPEV).

The appearance material of the polypropylene-based end piece 5 may comprise a proportion of at least approximately 90% by weight relative to the total weight of the end piece 5. Preferably, this proportion of polypropylene may be between 90% and 99% by weight relative to the total weight of the end piece 5. Even more preferably, the proportion of polypropylene may be between 95% and 99% by weight relative to the total weight of the end piece 5.

The end piece 5 may comprise at least one nucleating agent such as Sorbitol.

The nucleating agent may be in a proportion of 0.01 to 5% by weight.

The end piece 5 may have a Lab-type color difference ΔE of less than 15.

Preferably, this difference ΔE is less than 7. More preferably, this difference ΔE is less than 5. Even more preferably, this difference ΔE is less than 2.

Advantageously, the run channel 1 may preferably be made entirely of recyclable materials based on recycled polypropylene.

The present application will now describe the various possible integrations of the appearance finish end piece 5, in particular the first end piece 5a, in the run channel 1 of the disclosure.

FIGS. 5 to 7 illustrate a first, non-limiting embodiment of the run channel 1 wherein the first end piece 5a is formed by overmolding, for example with the appearance material.

The run channel 1 in the first embodiment comprises at least the first 2 and second 3 profiles, and possibly the third profile 6, as described above.

These first 2 and second 3 profiles are connected to each other in a secant manner by at least the connecting portion 4 as described above. This connecting portion 4 may comprise the first connecting portion 42 configured to connect the first 2 and second 3 profiles, and/or the second connecting portion 44 configured to connect the first 2 and third 6 profiles.

In the example shown in FIGS. 5 to 7, the first portion 42 may comprise the connecting end portion 4a. This end portion 4a may comprise at least:
a longitudinal tip 422 connected to the longitudinal portion 22 (with respect to the axis X), and
a radial tip 424 (relative to the axis Y) connected to the longitudinal tip 422 and to the first end 22a of the longitudinal portion 22.

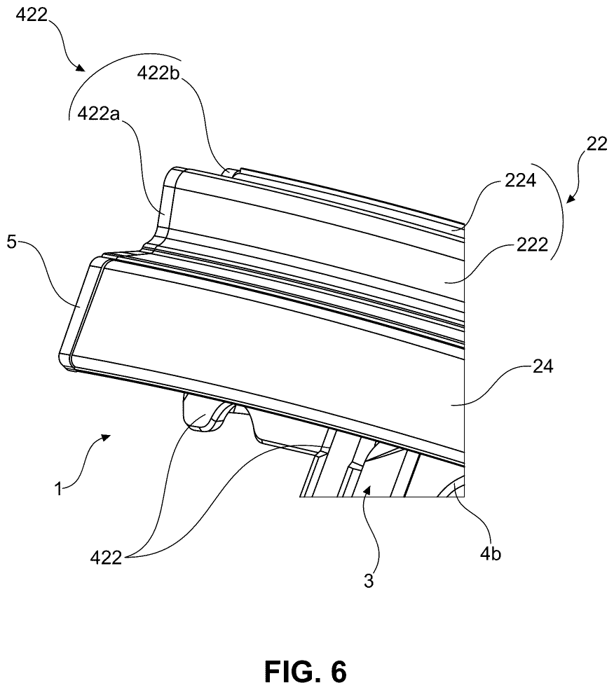

As illustrated in FIGS. 6 and 7, the longitudinal tip 422 may extend from the first longitudinal end 22a. More particularly, the longitudinal tip 422 may also allow the element of body C to be sealed. To this end, the longitudinal tip 422 may extend from each of the upper lips 222, 224 of the longitudinal portion 22. For example, the longitudinal tip 422 may comprise a first fraction 422a extending from the first upper sealing lip 222 and a second fraction 422b extending from the second upper sealing lip 224.

As shown in the example in FIGS. 5 to 7, the longitudinal tip 422 may be connected to also to the first end tip 32a of the second profile 3.

The radial tip 424 may extend radially (in particular towards the body 14 of the door) from the longitudinal tip 422, as shown in FIGS. 5 and 7.

The longitudinal tip and the radial tip 424 may be formed in one piece, in particular by the overmolding material.

The first portion 42 may comprise the curved connecting portion 4b. This curved portion 4b may connect the second tip 36a to the first longitudinal end 22a via at least part of the longitudinal tip 422.

In the example shown in FIGS. 5 to 7, the first portion 42 may be formed by the end portion 4a (such as the longitudinal 422 and radial 424 tips) and the curved portion 4b. These end portions 4a and curved portions 4b may be formed integrally with the first 2 and second 3 profiles by the overmolding material.

According to the first embodiment, the appearance finish end piece 5, 5a may comprise first 50 and second 52 parts connected together, for example in one-part. The first part 50 may form the visible outer part of the first end piece 5a. The second part 52 may be interposed between the first part 50 and at least a part of the radial tip 424.

The first end piece 5a according to the first embodiment may be made of a two materials. The first part 50 may be made from the appearance material which may comprise at least one finish identical to the coating 24 and form the end piece 5 covering the edge 24a of the coating 24. This allows to provide a continuous, uniform finish between the end piece 5, 5a and the coating 24, and significantly enhances the aesthetic appearance of the run channel 1. The second part 52 may be made from the appearance material, which may be identical to the overmolding material of the first connecting portion 42. This allows the first end piece 5 to be produced in one-part and integrally with the first connecting portion 42, making more robust the integration of this end piece 5, 5a into the run channel 1.

FIG. 8 illustrates a second, non-limiting embodiment of the run channel 1 of the disclosure, which differs from the run channel 1 of the first embodiment in that the end piece 5, 5a, 5b is injected into or fitted to the first profile 2. The run channel 1 according to the second embodiment comprises at least the first 2 and second 3 profiles, and possibly the third profile 6, as described above. These first 2 and second 3 profiles are connected to each other in a secant manner by at least the connecting portion 4 as described above. This connecting portion 4 may comprise the first connecting portion 42 configured to connect the first 2 and second 3 profiles (not visible in FIG. 8), and/or the second connecting portion 44 configured to connect the first 2 and third 6 profiles.

In particular, the first end piece 5a may be a separate part that is assembled on the edge 24a of the coating 24 and at least partly on the first longitudinal end 22a of the first profile. The second end piece 5b may also be a separate part that is assembled on the edge 24b of the coating 24 and at least partly on the second longitudinal end 22b. The second end piece 5b covers the edge 24b in the example shown in FIG. 8.

The end piece 5, 5a, 5b of the second embodiment may be made of a single material. The first part 50 may be made from the appearance material. This appearance material may comprise at least one finish identical to that of the appearance finish coating 24. This also allows to achieve a continuous, uniform finish between the end piece 5 and the coating 24, and therefore significantly enhances the aesthetic appearance of the run channel 1.

The present application will now describe a manufacturing method for manufacturing the run channel 1 of the disclosure, the successive steps of the method which are summarized in FIGS. 9 to 11, for example.

In accordance with the disclosure, the method comprises the following steps:
(a) producing the first and second profiles 2, 3, independently of each other by co-extrusion,
(b) positioning the first and second profiles 2, 3 in a mold,
(c) injecting the overmolding material into the mold to form the at least one portion 4 connecting the first and second profiles 2, 3, and
(d) forming or assembling the appearance finish end piece 5 on the longitudinal end 22a, 22b of the first profile 2.

Step (d) may be carried out before step (b), after step (c), or simultaneously with step (c).

In step (a), each of the first and second profiles 2, 3 comprises at least one of the sealing lips 222-229, as described above. The appearance finish coating 24 is co-extruded with the rest of the first profile 2.

In step (b), the mold may comprise several cavities for receiving the first 2 and second 3 profiles and forming the connecting portion 4 by overmolding. For example, the mold may comprise first and second cavities for receiving the first 2 and second 3 profiles respectively, and a third cavity for forming the connecting portion 4. This third cavity is located between the first and second cavities so as to form the first 2 and second 3 intersecting profiles. The third cavity may take the form of the first connecting portion 42 for connecting the first 2 and second 3 profiles or of the second connecting portion 44 for connecting the first 2 and third 6 profiles.

With reference to FIG. 9 and according to a first example, the manufacturing method for manufacturing the run channel 1 may comprise steps (a) to (d) in order. In this first example, step (d) of forming the appearance finish end piece 5 is carried out after step (c) by overmolding, in a different mold to that used for step (c) of injecting the overmolding material.

More particularly, the end piece 5 may be formed by overmolding, for example with the appearance material, on at least one of the longitudinal ends 22a, 22b of the first profile 2 and of the appearance finish coating 24.

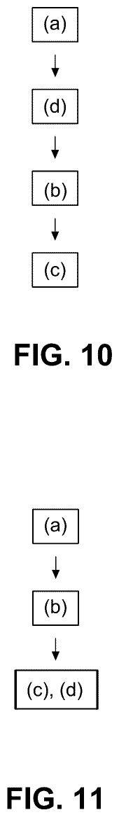

With reference to FIG. 10 and according to a second example of embodiment of the method for manufacturing the run channel 1, step (d) of forming the appearance finish end piece 5 is carried out before step (b) by overmolding in a mold different from that used for step (c) for injecting the overmolding material. The end piece 5 is formed by overmolding the appearance material.

FIG. 10 illustrates this second example, which may comprise the following steps in order:
(a) producing the first and second profiles 2, 3, independently of each other by co-extrusion,
(d) forming the appearance finish end piece 5 on the longitudinal end 22a, 22b of the first profile 2, by overmolding (for example with the appearance material) in a first mold,
(b) positioning the first and second profiles 2, 3 with the end piece 5 in a second mold, and
(c) injecting the overmolding material into the second mold to form the at least one portion 4 connecting the first and second profiles 2, 3.

According to a third example of embodiment of the method, step (d) of mounting the appearance finish end piece 5 is carried out before step (b) or after step (c), the end-piece 5 having previously been produced by injection-molding.

This third example may comprise the following steps in order:
(a) producing the first and second profiles 2, 3, independently of each other by co-extrusion,
(d) pre-forming the appearance finish end piece 5 and mounting on the longitudinal end 22a, 22b of the first profile 2,
(b) positioning the first and second profiles 2, 3 with the end piece 5 in the mold, and
(c) injecting the overmolding material into the mold to form the at least one connecting portion 4 connecting the first and second profiles 2, 3.

According to a fourth example of embodiment of the method, steps (c) and (d) are carried out simultaneously by bi-injection of the overmolding material to form the at least one connecting portion 4, 4a, 4b, and of the appearance material to form the end piece 5.

FIG. 11 illustrates this fourth example, which may comprise the following steps in order:
(a) producing the first and second profiles 2, 3, independently of each other by co-extrusion,
(b) positioning the first and second profiles 2, 3 in the mold, and
(c) and (d) injecting or bi-injecting the overmolding material into the mold to form the at least one portion 4 connecting the first and second profiles 2, 3, and of the appearance material to form the appearance finish end piece 5.

According to a variant embodiment of this fourth example, the overmolding material to form the connecting portion 4 may be identical to the appearance material used to form the end piece 5. For example, the overmolding material may be identical to the appearance material when the end piece 5 has a second matt finish.

According to another variant of embodiment of the fourth example, steps (c) and (d) may be carried out by bi-injection when the overmolding material for forming the connecting portion 4 is different from the appearance material to form the end piece 5.

In the present application, a distinction is made between a single injection and a bi-injection (or multi-injection). A simple injection may be defined as the injection of a single material into the mold, whereas a bi-injection may be defined as two injections, generally from two different materials, into the same mold.

1. A run channel for a movable window frame of a vehicle, this run channel comprising at least first and second profiles each comprising at least one sealing lip and connected to one another in a secant manner by at least one connecting portion, said first profile comprising an appearance finish coating which extends along this first profile and which comprises at least one first finish chosen from a gloss, a matting, a coloration and a surface finish different from that of the rest of the profile, wherein:
the first profile is formed by co-extrusion with said appearance finish coating,
the second profile is formed by co-extrusion, and
said at least one connecting portion is formed by an overmolding material, and
wherein the run channel comprises at least one appearance finish end piece which is located at at least one longitudinal end of said first profile and of said appearance finish coating, this end piece having at least one second finish chosen from a gloss, a matting, a coloration and a surface finish.

2. The run channel according to claim 1, wherein the appearance finish end piece and/or the appearance finish coating have a gloss greater than or equal to 70 GU at 60° and/or a flexural modulus of between 200 and 3000 MPa at ambient temperature.

3. The run channel as claimed in claim 1, wherein the appearance finish end piece and/or the appearance finish coating have a matting of less than or equal to 10 GU at 60° and/or a flexural modulus of between 200 and 500 MPa at ambient temperature.

4. The run channel according to claim 1, wherein the appearance finish end piece and/or the appearance finish coating comprise a material with a color difference (ΔE) of a Lab type of less than 15; preferably this difference (ΔE) is less than 7; more preferably this difference (ΔE) is less than 5; even more preferably this difference (ΔE) is less than 2.

5. The run channel according to claim 1, wherein the appearance finish end piece and/or the appearance finish coating comprise a material free of metal particles.

6. The run channel according to claim 1, wherein said appearance finish end piece is fitted or is formed by overmolding of an appearance material.

7. The run channel according to claim 1, wherein said appearance finish coating, or even said appearance finish end piece, comprises an appearance finish material based on polypropylene (PP), styrenic thermoplastic polyolefin (TPS), vulcanized thermoplastic (TPV), styrenic thermoplastic elastomer (TPES) or vulcanized thermoplastic elastomer (TPEV), and/or may comprise at least one nucleating agent in a proportion of 0.01 to 5% by weight.

8. The run channel according to claim 1, wherein the first and second finishes are identical.

9. The run channel according to claim 1, wherein the second finish is chosen from a matting and/or a surface finish.

10. The run channel according to claim 1, wherein the appearance finish coating has a thickness of less than 1 mm, and preferably the thickness of this coating 24 is between 0.25 and 0.90 mm.

11. A vehicle, in particular a motor vehicle, comprising at least one run channel according to claim 1.

12. A method for manufacturing a run channel according to claim 1, wherein the method comprises the following steps:
(a) producing the first and second profiles independently of each other by coextrusion, each of the first and second profiles comprising at least one sealing lip, the first profile comprising said appearance finish coating which is co-extruded with the rest of this first profile,
(b) positioning the first and second profiles in a mold, and
(c) injecting an overmolding material into the mold to form said at least one connecting portion (4) of said first and second profiles, and
(d) forming or mounting the appearance finish end piece on said longitudinal end of said first profile and said appearance finish coating, the step (d) being carried out before step (b), after step (c), or simultaneously with step (c).

13. A manufacturing method according to claim 12, wherein step (d) of forming the appearance finish end piece is carried out after step (c) or before step (b) by overmolding, in a different mold from the one used for step (c) of injecting the overmolding material.

14. The manufacturing method according to claim 12, wherein the step (d) of mounting the appearance finish end piece is carried out before step b) or after step c), the end piece being previously produced by injection-molding.

15. The manufacturing method according to claim 12, wherein steps (c) and (d) are carried out simultaneously by injection or bi-injection of the overmolding material to form said at least one connecting portion, and of an appearance material to form said end piece.
